(19) United States
(12) Patent Application Publication
(10) Pub. No.: US 2002/0083198 A1
(43) Pub. Date: Jun. 27, 2002

(54) Method of automatically generating IPv6 address using E.164 telephone number and of looking up IP address assigned to E.164 telephone number

(76) Inventors: Yong-Woon Kim, Taejon (KR); Jung-Soo Park, Taejon (KR); Myung-Ki Shin, Taejon (KR); Seung-Yun Lee, Taejon (KR); Yong-Jin Kim, Taejon (KR); Ki-Shik Park, Taejon (KR); Chee-Hang Park, Taejon (KR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/898,565

(22) Filed: Jul. 2, 2001

(30) Foreign Application Priority Data
Dec. 27, 2000 (KR) 2000-83013

(51) Int. Cl. G06F 15/16

(52) U.S. Cl. 709/245

(57) ABSTRACT

A method of automatically generating IPv6 unicast addresses in IPv6-based next-generation Internet communication environments using a telephone number of a E.164 format allocated to a telephone terminal, and a method of looking up 32-bit IPv4 addresses or 128-bit IPv6 addresses, which are previously allocated to name addresses consisted of E. 164 telephone numbers, from a DNS. An automatic creation relates to a method in which an Internet host as a sender of an IP packet creates an IP address and a search from the DNS indicates a process of looking up an IP address of a receiver. The method automatically generates an IP address of a sender based on a telephone number and a search of an IP address of a receiver using DNS.

### TECHNICAL FIELD

The invention relates generally to a method of automatically generating an IP address used in Internet communication using a telephone number and a method of looking up an IP address corresponding to a telephone number from DNS (domain name system) in which IP addresses assigned to domain name addresses or telephone numbers are stored. More particularly, the present invention relates to a method of automatically generating IPv6 unicast addresses in a IPv6-based next-generation Internet communication environment using a E.164 telephone number allocated to a telephone terminal, and a method of looking up 32-bit IPv4 addresses or 128-bit IPv6 addresses from DNS, using E.164 telephone numbers.

### BACKGROUND OF THE INVENTION

The 128-bit IPv6 address consists of a combination of a subnet prefix information and an interface ID, as shown in FIG. 1, and the unicast IPv6 address is composed of a combination of 64 bit prefix information and 64 bit interface ID, as shown in FIG. 2. The prefix information is allocated from the Internet authorities and an interface ID is automatically created using an identifier information allocated to a network interface card.

The way of automatically generating the interface ID is defined in RFC 2373, an Internet standard. In IPv6-based next-generation Internet communication environments, in order for the telephone terminal to which an unique IP address is allocated to act as a direct Internet host, the terminal must be capable of automatically generating IPv6 address called IPv6 auto-configuration. The present invention proposes a method of automatically generating IPv6 address using a telephone number.

Several IP addresses can be allocated to a single physical interface. Among these addresses, there are an IP address allocated arbitrarily and manually and managed by the address management system as well as an IP address generated automatically. Today, the DNS is used to lookup the IP address based on a domain name address. However, there is no method of looking up the IP address using the telephone number. In the telephone terminal, it is thought to be more convenient to look up the IP address using the telephone number than to look up the IP address using an English alphabet-based domain name address.

In the RFC 2916 being an Internet standard, there is defined a method of using E.164 telephone number and DNS. In this standard, it is specified that available service information is retrieved which is stored in the DNS database in the NAPRT record type by which a E.164 telephone number is converted into “e164.arpa” domain type, and the available service information is provided depending on the priority. In other words, this Internet standard lists the types of services that can be provided to corresponding telephone numbers. For example, if an Internet e-mail service is available for a certain telephone number, the telephone number user's e-mail address is stored in the DNS database and given with the service type for a request of available services. If an SIP (Session Initiation Protocol) service is available additionally, the service type with priority is stored and given by the priority information.

That is, it could be seen that a conventional RFC 2916 regards the telephone terminal as a terminal apparatus for providing services such as an e-mail service or SIP service, etc. Therefore, it needs to indicate only information regarding the types of services that the telephone terminal can provide and the service recipient information. These information can be selectively used depending on the priority. On the contrary, in the present invention, the telephone terminal is regarded as a miniaturized Internet host that accommodates all the various services in the Internet. Therefore, it corresponds the telephone number to an IP address.

Today's telephone, especially in case of a mobile phone, the telephone terminal has been considered as a perfect Internet host through a mobile wireless Internet service. Also, WAP (Wireless Application Protocol) being an important means for providing the mobile Internet service is adopting the IP-based protocol architecture. That is, the telephone terminal has been settled down as a perfect Internet host, not as a simple service access terminal. Therefore, such a new idea that a telephone number corresponds directly to an IP address may be important and have a very high effective in the future Internet environment.

### SUMMARY OF THE INVENTION

The present invention is contrived to solve the above problems and an object of the present invention is to provide a method of automatically generating IPv6 address using the telephone number of E.164 format allocated to the telephone terminal in an IPv6-based next-generation Internet communication environment.

Also, an other object of the present invention is to provide a method of looking up 32-bit IPv4 addresses or 128-bit IPv6 addresses from DNS, which are previously allocated to E.164 telephone number addresses.

In order to accomplish the above objects, a method of automatically generating IPv6 address using an E.164 telephone number according to the present invention is characterized in that it comprises a first step of reading in a telephone number of a telephone terminal, a second step of converting respective decimal numbers constituting the telephone number of the telephone terminal into a 4-bit binary format, a third step of padding a specific bit to the bit sequence converted in the second step to produce an interface ID having a pre-established size, and a fourth step of combining the interface ID and the prefix information to produce an IP address.

Also, according to the present invention, there is provided a computer-readable recording medium in which a program for executing an IPv6 Internet address automatic generating method using the above-mentioned telephone number is recorded.

Further, a method of looking up an IP address corresponding to a telephone number name address according to the present invention is characterized in that it comprises a first step of receiving a request for an IP address of the telephone number name address in a local domain DNS server, a second step of receiving a server address which points to a corresponding country DNS server using a country identification number of the telephone number name address in a client node, a third step of accessing a corresponding country DNS server recognized in the second step to recognize an address of a server for managing a corresponding local area DNS using a local identification number of the telephone number name address and a fourth step of accessing a corresponding local area DNS server recognized in the third step to recognize an IP address of a corresponding subscriber's telephone number using a subscriber's telephone number of the telephone number name address.

Also, according to the present invention, there is provided a computer-readable recording medium on which a program for executing an IPv6 Internet address automatic generating method using the above-mentioned telephone number is recorded.

In addition, a DNS server system for resolving an IP address for a telephone number name address according to the present invention is characterized in that it comprises a root DNS server for managing country DNS server addresses corresponding to country identification numbers of the telephone number name address, a country DNS server for managing local area DNS server addresses corresponding to local identification numbers of the telephone number name address, a local domain DNS server for managing prefix DNS server addresses or IP addresses corresponding to prefix identification numbers of the telephone number name address, and a subject DNS server for looking up an IP address corresponding to the telephone number name address to provide an address resolver in a client node with the IP address, through the root DNS server, a country DNS server, a local area DNS server, and a local domain DNS server.

### BRIEF DESCRIPTION OF THE DRAWINGS

The aforementioned aspects and other features of the present invention will be explained in the following description, taken in conjunction with the accompanying drawings, wherein:

FIG. 1 shows a construction of an IPv6 Internet address,

FIG. 2 shows a construction of an IPv6 unicast Internet address,

FIG. 3 shows an E.164 number architecture for a communication network standardized by ITU-T,

FIG. 4 is a flowchart for illustrating an automatic IPv6 Internet address generating method using E.164 format telephone number according to one embodiment of the present invention,

FIG. 5 is a conversion table showing the rule by which decimal number having E.164 format telephone numbers into binary bit sequence,

FIG. 6A and FIG. 6B are flowcharts showing an IP address lookup method for E.164 format name address according to one embodiment of the present invention, and

FIG. 7 is a different view of a process for looking up an IP address from a DNS for E.164 format name address according to one embodiment of the present invention.

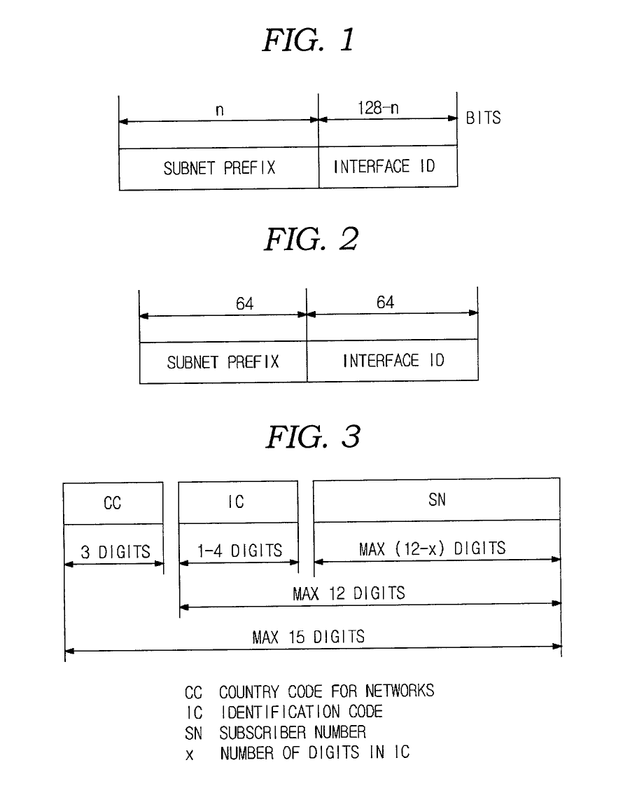

### DETAILED DESCRIPTION OF THE INVENTION

A method of automatically generating IPv6 address using E.164 telephone number and of looking up IP address assigned to E.164 telephone number will be explained by way of a preferred embodiment with reference to accompanying drawings as described below. Here, an Internet address automatic generation indicates that an Internet host, as a sender of an IP packet, creates for itself an IP address that it will use. On the other hands, an Internet address automatic looking up indicates that it looks up an IP address of the recipient. The present invention suggests a method of automatically generating an IP address of the sender based on the telephone number and of looking up an IP address of the recipient from DNS.

As shown in FIG. 2, an IPv6 unicast address architecture consists of upper 64-bit subnet prefix information and lower 64-bit interface ID information. The interface ID information is an interface address allocated to a network interface card. The subnet prefix information and the interface ID information are combined to produce an IPv6 address, automatically.

A telephone terminal has no address such as IEEE 802 MAC (Medium Access Control) address by which a communication network interface location can be identified. On the other hand, a mobile phone has a serial number given by a manufacturer. However, as every manufacturer has different numbering architectures, the serial number could not be used as an interface address. Therefore, the present invention generates IPv6 unicast addresses based on telephone numbers given to respective telephone terminals.

The public telecommunication number structure is defined in ITU-T E.164 standard, which defines three types of numbering schemes for geographic areas, global services and communication network. The structure has all decimal of maximum 15 digits. In FIG. 3, there is shown a telephone number system for a communication network.

As decimal numbers from 0 to 9 can be expressed using 4 bits, the maximum 15-digit decimal may be expressed into 60 bits. When this is to be stored in a 64-bit interface ID area, as there are short of 4 bits, upper 4 bits are padded to 0. Prefix information is aggregated with a telephone number-based 64-bit interface ID generated, thereby producing an unicast IPv6 address.

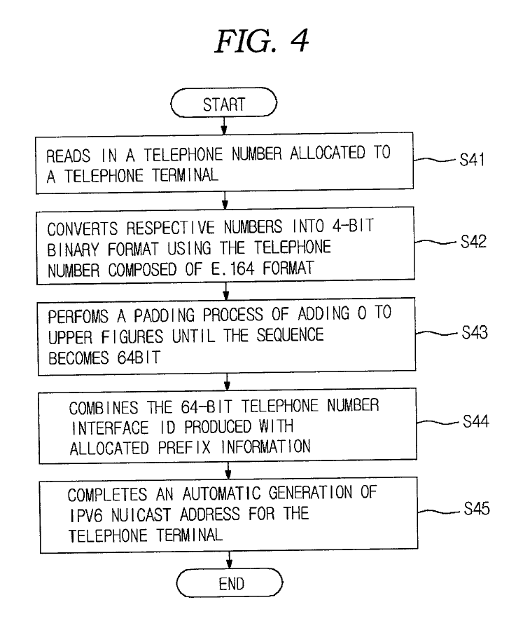

Referring now to FIG. 4, a flowchart for illustrating an automatic IPv6 Internet address generating method using E.164 format telephone number according to one embodiment of the present invention, will be explained in detail below.

First, the IPv6 protocol engine reads in a telephone number allocated to a telephone terminal (S41). At this time, the terminal telephone number should be composed of a complete shape in an order of a country identification number, a local identification number and a subscriber telephone number based on the E.164 format and it is required to provide an E.164 format telephone number of a complete shape in response to the request for a telephone number that the IPv6 protocol engine calls. For this, it is required that a communication protocol of a mobile phone or a general telephone have the function of acquiring the E.164 telephone number allocated to the terminal, or that the terminal itself have the function of storing country and local identification numbers of the terminal and a subscriber's telephone number. These additional functional conditions are no more than additional function that is accompanied by an extension of function through which the telephone terminal performs an IP protocol communication as an Internet host.

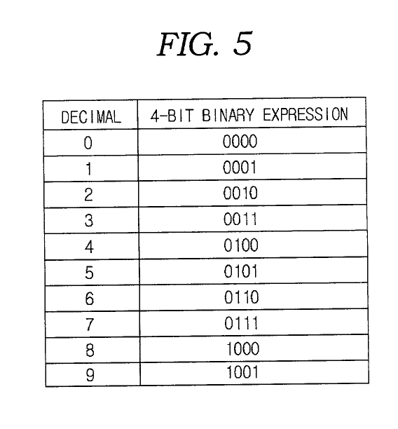

Next, each of decimal numbers is changed into 4 bit binary format, as shown in FIG. 5 (S42). At this time, as the telephone number defines the maximum 15 digits in E.164 format, it may have a sequence of decimal numbers below 15 digits.

Then, as the above binary bit sequence has the maximum 60 bits or below thereof, a padding process proceeds to add 0 to upper bit digits until the sequence becomes 64 bit (S43). Through these processes, an interface ID having the size of 64 bits is created.

Thereafter, the 64-bit telephone number interface ID is combined with a prefix information that is allocated administratively by a super-user (S44). Thus, an automatic creation of IPv6 unicast address for the telephone terminal is finished (S45). As a result, the Internet host, as a sender, can transmit IP packets by using the created address as the source IP address. The Internet host has to know the IP address of the receiver in order to send the IP packets. At this time, the user's client program may directly give the Internet host the receiver's IP address, or the domain name address instead of the IP address, or the telephone number of the E.164 format as intended in the present invention.

In case that the receiver's IP address is given, the IP protocol engine can directly transmit an IP datagram packet by using the sender's and receiver's IP addresses. However, in case that the domain name address or the telephone number of E.164 format is given, a process by which an IP address is looked up through DNS must be added. But, the process by which the IP address is looked up in case that the domain name address is given is operated by means of a conventional DNS protocol mechanism. Thus, in the present invention, a method of looking up the IP address in case that the name address in the E.164 telephone number format is given, will be explained.

The operation of the telephone terminal serving as a client will be first explained. First, as a basic prerequisite, an identifier for displaying a name address using the telephone number of E.164 format is represented as “#”. For example, the name address using the tel□àephone number can be expressed into #82-2-123-4567, #042-123-4567, etc. Second, any space could not be located between the numbers. As in the previous example, respective identifiers can be identified using “−” or respective identifiers could be sequentially inputted as in #0421234567. Third, the name address comprising only a subscriber's telephone numberor short of a country identification number and a local identification number, for example, #123-4567 is not allowed

The client program transfers a telephone number name address of E.164 format to the address resolver of a client node via a user's interface. Then, the address resolver recognizes that it is the name address of E.164 format through # indication and then removes all the letters other than the decimal digits by eliminating the # indication from the telephone number. For example, if the user inputs a telephone number name address, #82-42-123-4567, the address resolver combines only the decimal digits to make “#82421234567”. Then, it requests the DNS server for an IP address corresponding to the name address by using the DNS protocol.

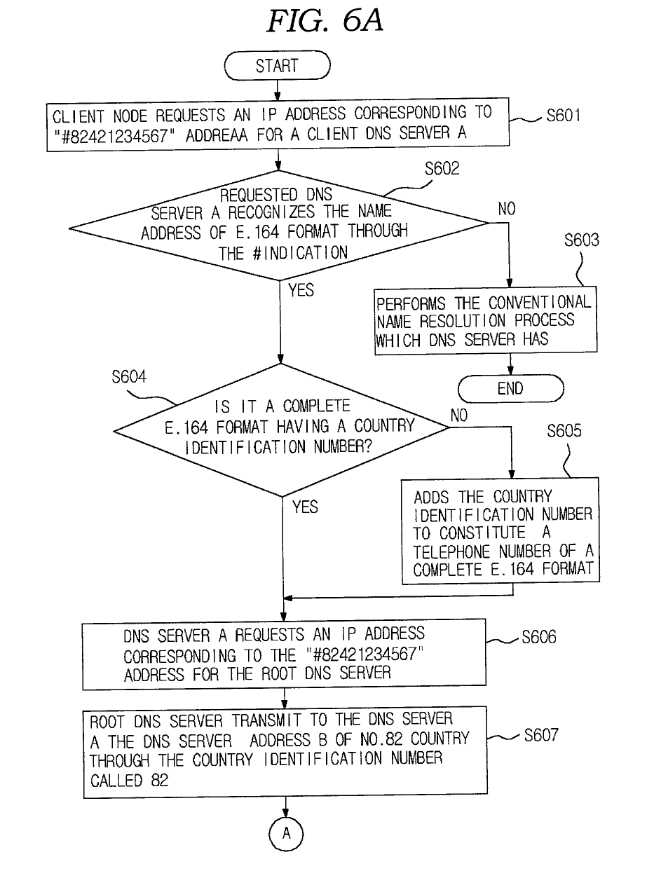

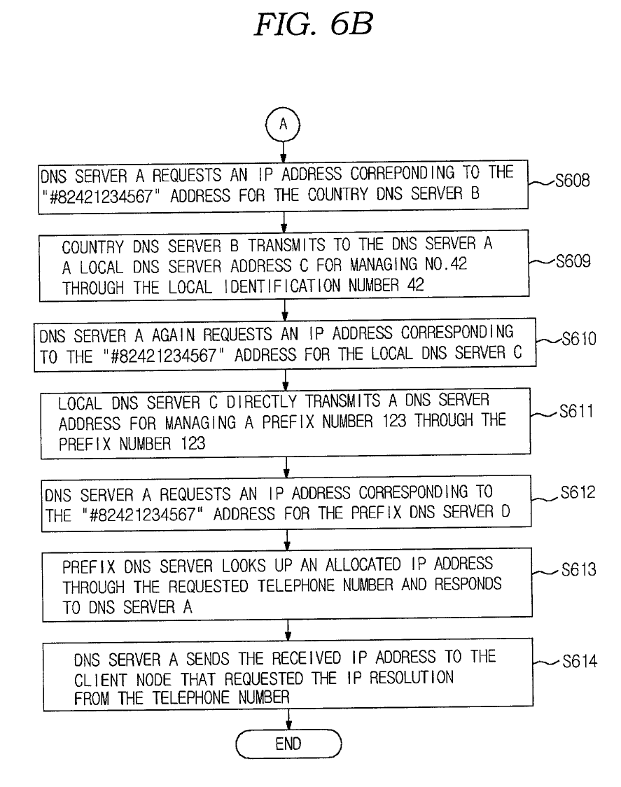

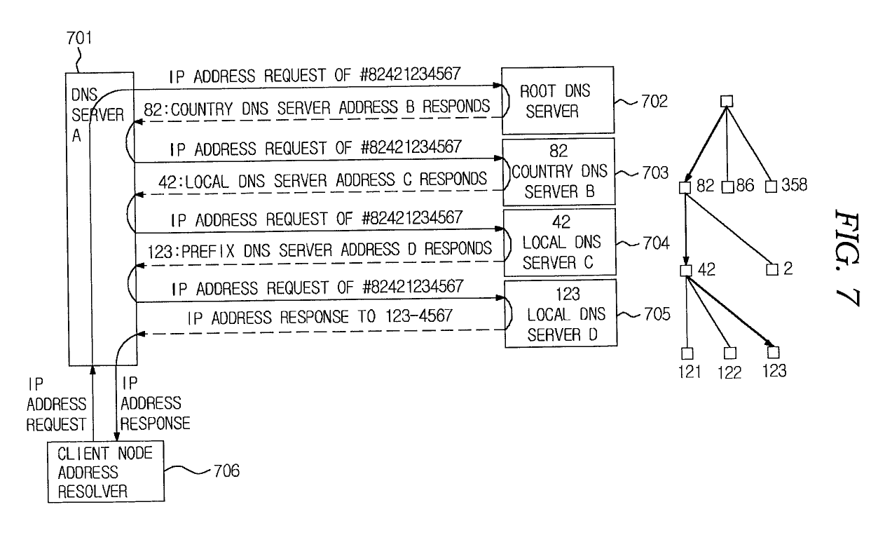

If the IP address request message for the telephone number name address is received, the DNS server implements the procedure shown in FIGS. 6A and 6B. First, operations of each of the constituent elements in FIG. 7 will be first examined in order to facilitate understanding of the procedure of FIGS. 6A and 6B. A DNS server A 701 is a local area DNS server providing an IP address corresponding to a telephone number name address at the request of an address resolver 706. A root DNS server 702 provides the DNS server A 701 with a server address (country DNS server B 703) for managing a corresponding country DNS by using a country identification number, when a request for the IP address corresponding to the telephone number name address is received from the DNS server A 701. A country DNS server 703 provides the DNS server A 701 with a server address (local area DNS server C 704) for managing a corresponding local area DNS by using a local identification number, when a request for the IP address corresponding to the telephone number name address is received from the DNS server A 701.

The local area DNS server 704 provides the DNS server A 701 with a server address (prefix DNS server D 705) for managing a corresponding prefix DNS by using a prefix identification number, when a request for the IP address corresponding to the telephone number name address is received from the DNS server A 701. When receiving a request for the IP address corresponding to the telephone number name address from the DNS server A 701, the prefix DNS server 705 responds to the request for searching the IP address by using a subscriber's telephone number.

These processes will be explained taking an E.164 telephone number name address of “#824212134567” as an example. If the name address of #824212134567 is inputted to the DNS server A from the client node address resolver 706, the DNS server A 701 asks the root DNS server 702 for an IP address corresponding to #824212134567. Then, in response to it, the root DNS server 702 identifies a country from the telephone number name address and then informs the DNS server A 701 of an address of the DNS server corresponding to the country, that is, country's DNS server B information. Next, if the DNS server A 701 asks the country DNS server B 703 in an address provided from the root DNS server 702 for an IP address of “#824212134567”, the corresponding country DNS server B 703 identifies a corresponding local area from the telephone number name address and then informs the DNS server A 701 of an address corresponding to the DNS server, that is, a local area DNS server C information.

Then, if the DNS server A 701 ask the local area server C 704 for the address provided from the country DNS server B 703 for an IP address of “#824212134567”, a corresponding local area DNS server C 704 identifies a prefix from the telephone number name address and then informs the DNS server A 701 of an address of the DNS server corresponding to a prefix, that is, a local area DNS server D information. Next, if the DNS server A 701 ask the prefix DNS server D 705 for the address provided from the local area DNS server D 704 for an IP address of “#824212134567”, the corresponding prefix DNS server D 705 looks up an IP address corresponding to a subscriber telephone number from the telephone number name address and then informs the DNS server A 701 of the IP address.

It could be seen that this DNS database system translating an E.164 telephone number name address into an IP address is completely same to a conventional DNS database system which provides translations from a domain name address into an IP address. As only one difference, the conventional database system is constituted based on the domain name while the DNS database system according to the present invention is constituted based on the telephone number of E.164 format. Therefore, it can be said that their basic operations may be same.

FIGS. 6A and 6B show flowcharts for illustrating a process of looking up an IP address from a telephone number name address, “#82421234567”.

First, the address resolver in the client node asks the DNS server A for an IP address corresponding to the telephone number name address of E.164 format (S601). Then, the DNS server A determines whether or not it is the address of E.164 format by means of # indication (S602). If it is not the telephone number name address but a domain name address, the DNS server A performs the conventional name resolution process (S603). At this time, the telephone number name address may be a complete format including country and local area identification numbers or may include only a local identification number, which is separated for a geographical local or a service area. The DNS server A resolves the telephone number and thus determines whether or not the telephone number name address includes a country identification number (S604). As a result of the determination, if it is an incomplete format, the DNS server A adds the country identification number allocated to the DNS server A, thereby constituting a telephone number of a complete E.164 format (S605).

After the telephone number having the complete E.164 format is constituted, the DNS server A asks the root DNS server for an IP address corresponding to the telephone number name address “#82421234567”(S606). Then, the root DNS server transfers to the DNS server A DNS server address B corresponding to the No. 82 country by means of a country identification number, “82” (S607). Next, the DNS server A asks the country DNS server B for an IP address corresponding to the telephone number name address “#82421234567” (S608).

Thereafter, the country DNS server B transfers to the DNS server A a local area DNS server address C for managing corresponding local or service area by means of the local identification number (S609). At this time, the DNS server A again asks the local area DNS server C for an IP address corresponding to the telephone number name address “#82421234567”(S610). At this time, the local area DNS server C may directly have an IP address for the corresponding telephone number name address or may have only DNS server address information for separately managing subscriber's prefixes. It adequately responds with corresponding IP address (S611).

If the DNS server A receives DNS server address D information for managing prefixes, it asks the prefix DNS server D for an IP address corresponding to the telephone number name address “#82421234567”(S612). Then, the prefix DNS server D searches registered telephone numbers and IP address database to look up an allocated IP address and then transfers the IP address to the DNS server A (S613).

The DNS server A transfers an IP address allocated to the telephone number name address as a final answer to the client node address resolver (S614). Then, the address resolver in the client node receives the IP address for a telephone number name address of E.164 format.

As mentioned above, according to the present invention, when a telephone terminal loaded with an IP protocol is used as a host using an Internet service, it may be more effective to use a telephone number, which is already allocated and is conveniently employed, rather than using an alphabetic domain name address, thereby allowing an user to easily access the Internet using the telephone terminal.

Also, according to the present invention, when a telephone terminal creates automatically its own IP address in order to operate as a sender in an IPv6 communication environment, it can create the IP address based on a telephone number. Therefore, the present invention can have an IP address without additional operation mechanisms such as DHCP (dynamic host configuration protocol). In addition, in order for a sender to transmit an IP packet to a receiver, the sender must have an IP address of the receiver having a telephone number-based name address. According to the present invention, the IP packet can be simply transferred by incorporating the function of resolving the telephone number of E.164 format and a database into a DNS server using a conventional DNS operating mechanism without any modification.

The present invention has been described with reference to a particular embodiment in connection with a particular application. Those having ordinary skill in the art and access to the teachings of the present invention will recognize additional modifications and various applications within the scope thereof.

It is therefore intended by the appended claims and the equivalents thereof to cover any and all such applications, modifications, and embodiments within the scope of the present invention.

What is claimed:

1. A method of automatically generating an IPv6 address using an E.164 telephone number, comprising:
a first step of reading in the telephone number of a telephone terminal;
a second step of converting respective decimal numbers constituting the telephone number of the telephone terminal into a 4-bit binary format;
a third step of padding a specific bit to the bit sequence converted in said second step to produce an interface ID having a pre-established size; and
a fourth step of combining said interface ID and the prefix information to produce an IP address.

2. The method of automatically generating an IPv6 address using an E.164 telephone number according to claim 1, wherein said first step reads in the telephone number of the telephone terminal in accordance with E.164 format.

3. The method of automatically generating an IPv6 address using an E.164 telephone number according to claim 2, wherein said telephone number of said telephone terminal comprises a country identification number, a local identification number and a subscriber telephone number.

4. The method of automatically generating an IPv6 address using an E.164 telephone number according to claim 1, wherein said fourth step combines the prefix information of 64 bit and the interface ID of 64 bit created using the E.164 telephone number to thereby produce an IPv6 unicast address.

5. The method of automatically generating an IPv6 address using an E.164 telephone number according to claim 4, wherein said third step pads 0 or 1 bit to upper or lower bit digits of said binary bit sequence to produce the interface ID of 64 bit.

6. A computer-readable recording medium having a program embedded thereon for executing a method of automatically generating an IPv6 address using an E.164 telephone number, said method comprising:
a first step of reading in a telephone number of a telephone terminal;
a second step of converting respective decimal numbers constituting the telephone number of the telephone terminal into a 4-bit binary format;
a third step of padding a specific bit to the bit sequence converted in said second step to produce an interface ID having a pre-established size; and
a fourth step of combining said interface ID and the prefix information to produce an IP address.

7. A method of looking up an IP address corresponding to a telephone number name address, comprising:
a first step of receiving a request for an IP address of said telephone number name address in a local domain DNS server;
a second step of receiving a server address which points to a corresponding country DNS server using a country identification number of said telephone number name address in a client node;
a third step of accessing a corresponding country DNS server recognized in said second step to recognize an address of a server for managing a corresponding local area DNS, using a local identification number of said telephone number name address; and
a fourth step of accessing a corresponding local area DNS server recognized in said third step to recognize an IP address of a corresponding subscriber's telephone number, using a subscriber's telephone number of said telephone number name address.

8. The method according to claim 7, wherein said fourth step recognizes an address of a server for managing a corresponding prefix DNS using a prefix identification number of said telephone number name address by accessing the corresponding local area DNS server recognized in said third step, and recognizes an IP address of said subscriber's telephone number by accessing said corresponding prefix DNS server.

9. The method according to claim 7, wherein said first step adds a country identification number to the telephone name number address, if said telephone number name address includes only a local identification number and a subscriber's telephone number, and then performing said second step.

10. The method according to claims 7, wherein said telephone number name address is a telephone number of E.164 format.

11. The method according to claim 10, wherein a special character is formed at the front of a telephone number of said E.164 format.

12. A computer-readable recording medium having a program written thereon in a computer,
said program executes a method of looking up an IP address using a telephone number, comprising:
a first step of, if a request for an IP address of a telephone number name address is received by a local domain DNS server, receiving a server address which points to a corresponding country DNS server using a country identification number of said telephone number name address in a client node;
a second step of accessing a corresponding country DNS server recognized in said first step to recognize an address of a server for managing a corresponding local area DNS, using a local identification number of said telephone number name address; and
a third step of accessing a corresponding local area DNS server recognized in said second step to recognize an IP address of a corresponding subscriber's telephone number, using a subscriber's telephone number of said telephone number name address.

13. A DNS server system for resolving an IP address for a telephone number name address, comprising:
a root DNS server for managing country DNS server addresses corresponding to country identification numbers of said telephone number name address;
a country DNS server for managing local area DNS server addresses corresponding to local identification numbers of said telephone number name address;
a local domain DNS server for managing prefix DNS server addresses or IP addresses corresponding to prefix identification numbers of said telephone number name address; and
a subject DNS server for looking up an IP address corresponding to said telephone number name address to provide an address resolver in a client node with the IP address, through said root DNS server, a country DNS server, a local area DNS server and a local domain DNS server.

14. The DNS server system for resolving an IP address for a telephone number name address according to claim 13, further comprising a prefix DNS server for managing IP addresses corresponding to subscriber's telephone numbers of said telephone number name address.
